(19) United States
(12) Patent Application Publication
(10) Pub. No.: US 2024/0411322 A1
(43) Pub. Date: Dec. 12, 2024

(54) METHOD AND APPARATUS FOR CLEANING SWIMMING POOLS, AND ELECTRONIC DEVICE AND STORAGE MEDIUM THEREOF

(71) Applicant: Suzhou Smorobot Technology Co., Ltd., Suzhou City (CN)

(72) Inventor: Zhongchao DING, Beijing (CN)

(73) Assignee: Suzhou Smorobot Technology Co., Ltd., Suzhou City (CN)

(21) Appl. No.: 18/808,012

(22) Filed: Aug. 18, 2024

Related U.S. Application Data
(63) Continuation of application No. PCT/CN2022/076905, filed on Feb. 18, 2022.

(51) Int. Cl. G05D 1/648; G05D 1/246; G05D 105/10; G05D 107/00; G05D 109/30

(52) U.S. Cl. CPC G05D 1/6482; G05D 1/246; G05D 2105/10; G05D 2107/29; G05D 2109/38

(57) ABSTRACT

The present disclosure provides a method and apparatus for cleaning a swimming pool, and an electronic device and a storage medium thereof. The method includes: controlling a swimming pool cleaning robot to move, with respect to a grid map covering the swimming pool, in a work area defined in the swimming pool to establish a cleaning map including a plurality of cleaning blocks; and controlling the swimming pool cleaning robot to traverse each of the cleaning blocks in the cleaning map to clean the swimming pool. According to the present disclosure, the cleaning regions may be accurately constructed in the map according to the work area in the swimming pool, such that the swimming pool cleaning robot cleans the swimming pool in a quick, efficient, and energy-saving fashion.

### CROSS-REFERENCE TO RELATED APPLICATION

This application is a continuation of International Application No. PCT/CN2022/076905 filed on Feb. 18, 2022, and entitled “METHOD AND APPARATUS FOR CLEANING SWIMMING POOLS, AND ELECTRONIC DEVICE AND STORAGE MEDIUM THEREOF,” the contents of which is hereby incorporated by reference in its entirety.

### TECHNICAL FIELD

Embodiments of the present disclosure relate to the field of cleaning control technologies, and in particular, relate to a method and apparatus for cleaning a swimming pool, and an electronic device and a computer storage medium thereof.

### BACKGROUND

A swimming pool cleaning robot is developed for cleaning a swimming pool, and is capable of repeatedly cleaning the bottom and walls of the swimming pool, and filtering the water in the swimming pool.

A conventional swimming pool cleaning robot, during performing a cleaning task, fails to reasonably plan a cleaning path, thereby causing problems that a long time for the cleaning robot is taken to clean a swimming pool, cleaning coverage is insufficient, and power consumption for the cleaning is large. As such, user experience of such products is affected.

Therefore, an improved solution for planning a swimming pool cleaning path is desired, such that a more suitable cleaning path is planned. With the suitable cleaning path, a swimming pool cleaning task may be efficiently performed.

### SUMMARY

In view of the above, embodiments of the present disclosure provide an improved solution for cleaning a swimming pool, which may at least partially solve the above technical problem.

According to one aspect of the present disclosure, a method for cleaning a swimming pool is provided. The method includes: controlling a swimming pool cleaning robot to move, with respect to a grid map covering the swimming pool, in a work area defined in the swimming pool to establish a cleaning map including a plurality of cleaning blocks; and controlling the swimming pool cleaning robot to traverse each of the cleaning blocks in the cleaning map to clean the swimming pool.

In one or more embodiments of the present application, the controlling the swimming pool cleaning robot to move, with respect to the grid map covering the swimming pool, in the work area defined in the swimming pool to establish the cleaning map including the plurality of cleaning blocks includes: controlling the swimming pool cleaning robot to move, with respect to the grid map, in the work area defined in the swimming pool to determine the plurality of cleaning blocks in the grid map; and establishing the cleaning map according to the plurality of cleaning blocks determined in the grid map.

In one or more embodiments of the present application, the controlling the swimming pool cleaning robot to move, with respect to the grid map, in the work area defined in the swimming pool to determine the plurality of cleaning blocks in the grid map includes: a moving step of controlling the swimming pool cleaning robot to move with respect to the grid map according to a predetermined map establishment movement algorithm; a marking step of marking a grid block reachable by the swimming pool cleaning robot in the grid map as a cleaning block and marking a grid block unreachable by the swimming pool cleaning robot in the grid map as a non-cleaning block, according to a movement result of the swimming pool cleaning robot with respect to the grid map; and alternately performing the moving step and the marking step until the grid map satisfies a predetermined block marking stop condition.

In one or more embodiments of the present application, the moving step includes: determining a grid block in the grid map, where the swimming pool cleaning robot is currently located, as a current block; determining at least one grid block that is adjacent to the current block and is not marked in the grid map as a candidate block on the basis of the current block; and determining a target block in the candidate block on the basis of the predetermined map establishment movement algorithm, and controlling the swimming pool cleaning robot to move from the current block to the target block.

In one or more embodiments of the present application, the determining the target block in the candidate block on the basis of the predetermined map establishment movement algorithm includes: determining, when there are a plurality of candidate blocks adjacent to the current block, a candidate block with a shortest movement path with respect to the swimming pool cleaning robot or a least time consumption for movement of the swimming pool cleaning robot in the plurality of candidate blocks as the target block on the basis of the predetermined map establishment movement algorithm, and determining all the other candidate blocks other than the target block in the plurality of candidate blocks as to-be-marked blocks.

In one or more embodiments of the present application, the predetermined map establishment movement algorithm includes: moving forward on the basis of a current orientation of the swimming pool cleaning robot; and in response to a failure to move forward on the basis of the current orientation of the swimming pool cleaning robot, moving forward after performing a steering operation on the basis of the current orientation of the swimming pool cleaning robot and a predetermined rotation angle, or moving backward on the basis of the current orientation of the swimming pool cleaning robot; wherein the predetermined rotation angle includes a 90-degree clockwise rotation angle or a 90-degree counterclockwise rotation angle on the basis of the current orientation of the swimming pool cleaning robot.

In one or more embodiments of the present application, the method further includes: acquiring, when there is no candidate block adjacent to the current block, each of the to-be-marked blocks in the grid map; determining a to-be-marked block with a shortest movement distance with respect to the current block as the target block on the basis of a predetermined path-finding algorithm; and controlling the swimming pool cleaning robot to move from the current block to the target block on the basis of the predetermined path-finding algorithm.

In one or more embodiments of the present application, the alternately performing the moving step and the marking step until the grid map satisfies the predetermined block marking stop condition includes: repeatedly performing the moving step and the marking step until all the grid blocks adjacent to each of the cleaning blocks in the grid map are marked.

In one or more embodiments of the present application, the method further includes: acquiring a plurality of cleaning regions in the cleaning map according to each of the cleaning blocks in the cleaning map.

In one or more embodiments of the present application, the controlling the swimming pool cleaning robot to traverse each of the cleaning blocks in the cleaning map to clean the swimming pool includes: an inter-region moving step of controlling the swimming pool cleaning robot to move in different cleaning regions on the basis of the predetermined path-finding algorithm; an intra-region moving step of controlling the swimming pool cleaning robot to move in each of the cleaning regions on the basis of a predetermined cleaning movement algorithm; and alternately performing the inter-region moving step and the intra-region moving step until the swimming pool cleaning robot traverses each of the cleaning regions in the cleaning map.

In one or more embodiments of the present application, the acquiring the plurality of cleaning regions in the cleaning map according to each of the cleaning blocks in the cleaning map includes: identifying a non-contiguous single cleaning block in the cleaning map, and acquiring a cleaning region including the single cleaning block; or identifying a plurality of cleaning blocks that are in a same row or column and contiguous in the cleaning map, and acquiring a cleaning region including the plurality of cleaning blocks.

In one or more embodiments of the present application, each of the cleaning regions includes two region endpoints, wherein the region endpoints are determined by the cleaning blocks at two ends of the cleaning region; and the inter-region moving step includes: determining a region endpoint having a shortest movement distance from the swimming pool cleaning robot as a target endpoint on the basis of the predetermined path-finding algorithm according to region endpoints of a cleaning region where the swimming pool cleaning robot is currently located, and two region endpoints of each of cleaning regions that are not cleaned in the cleaning map, and determining a cleaning region including the target endpoint as a cleaning region to be cleaned by the swimming pool cleaning robot; and controlling, on the basis of the predetermined path-finding algorithm, the swimming pool cleaning robot to move towards the target endpoint to move from the cleaning region where the swimming pool cleaning robot is currently located to the cleaning region to be cleaned, and continuing to perform the intra-region moving step in response to updating the cleaning region to be cleaned as the cleaning region where the swimming pool cleaning robot is currently located.

In one or more embodiments of the present application, the intra-region moving step includes: determining one region endpoint matching the target endpoint in the two region endpoints of the cleaning region where the swimming pool cleaning robot is currently located as a starting endpoint, and determining the other region endpoint in the two region endpoints as an ending endpoint; and controlling the swimming pool cleaning robot to move from the starting endpoint to the ending endpoint to traverse each of the cleaning blocks in the cleaning regions, and continuing to perform the inter-region moving step.

In one or more embodiments of the present application, the method further includes: determining a region endpoint that has a shortest movement distance from the swimming pool cleaning robot and located at an edge position of the cleaning map as a target endpoint on the basis of the predetermined path-finding algorithm according to a cleaning block in the cleaning map where the swimming pool cleaning robot is currently located, and two region endpoints of each of cleaning regions that are not cleaned in the cleaning map, and determining a cleaning region including the target endpoint as a cleaning region to be cleaned by the swimming pool cleaning robot; and controlling the swimming pool cleaning robot to move towards the target endpoint on the basis of the predetermined path-finding algorithm, updating the cleaning region to be cleaned as the cleaning region where the swimming pool cleaning robot is currently located in response to reaching the target endpoint, and continuing to perform the intra-region moving step.

In one or more embodiments of the present application, a size of each of the grid blocks in the grid map is determined on the basis of a predetermined stepping distance of the swimming pool cleaning robot.

In one or more embodiments of the present application, the predetermined path-finding algorithm includes an A-STAR algorithm.

According to another aspect of the present disclosure, an apparatus for cleaning a swimming pool is provided. The apparatus includes: a map generating module, configured to control a swimming pool cleaning robot to move, with respect to a grid map covering the swimming pool, in a work area defined in the swimming pool to establish a cleaning map including a plurality of cleaning blocks; and a cleaning control module, configured to control the swimming pool cleaning robot to traverse each of the cleaning blocks in the cleaning map to clean the swimming pool.

In one or more embodiments of the present application, the apparatus is mounted in the swimming pool cleaning robot, and the swimming pool cleaning robot is applicable to cleaning the swimming pool.

According to still another aspect of the present disclosure, an electronic device is provided. The electronic device includes: a processor; and a memory storing a program therein; wherein the program includes one or more instructions, and the processor, when executing the one or more instructions, is caused to perform the method as described above.

According to yet still another aspect of the present disclosure, a non-transitory computer-readable storage medium storing one or more computer instructions therein is provided, wherein the one or more computer instructions, when executed by a computer, cause the computer to perform the method as described above.

With the method and apparatus for cleaning the swimming pool, and the electronic device and the computer storage medium thereof according to the present disclosure, the swimming pool cleaning robot is controlled to move, with respect to the grid map, in the work area defined in the swimming pool, such that the work area in the swimming pool is accurately mapped to the cleaning blocks in the grid map, and accuracy of generating the cleaning map is improved.

Further, according to the present disclosure, the swimming pool cleaning robot is driven to clean the swimming pool on the basis of the cleaning blocks in the cleaning map, such that the swimming pool cleaning task may be quickly and efficiently performed. In this way, the time consumption may be reduced, and cleaning energy consumption may also be lowered.

### BRIEF DESCRIPTION OF THE DRAWINGS

The accompanying drawings are merely for schematic description and demonstration of the present disclosure, instead of limiting the scope of the present disclosure.

FIG. 1 is a schematic flowchart of a method for cleaning a swimming pool according to one exemplary embodiment of the present disclosure;

FIG. 2 is a schematic diagram of an application scenario of a grid map and a predetermined map establishment movement algorithm of a swimming pool cleaning robot according to one exemplary embodiment of the present disclosure;

FIG. 3 is a schematic flowchart of a method for cleaning a swimming pool according to another exemplary embodiment of the present disclosure;

FIG. 4 is a schematic flowchart of a method for cleaning a swimming pool according to another exemplary embodiment of the present disclosure;

FIG. 5 is a schematic flowchart of a method for cleaning a swimming pool according to another exemplary embodiment of the present disclosure;

FIG. 6A to FIG. 6C are schematic diagrams of cleaning region planning according to one exemplary embodiment of the present disclosure;

FIG. 7 is a schematic flowchart of a method for cleaning a swimming pool according to another exemplary embodiment of the present disclosure;

FIG. 8 is a structural block diagram of an apparatus for cleaning a swimming pool according to one exemplary embodiment of the present disclosure; and

FIG. 9 is a structural block diagram of an electronic device according to one exemplary embodiment of the present disclosure.

### REFERENCE NUMERALS AND DENOTATIONS THEREOF

800-apparatus for cleaning swimming pool; 802-map generating module; 804-cleaning control module; 900 electronic device; 901-computing unit; 902-ROM; 903-RAM; 904-bus; 905-input/output interface; 906-input unit; 907-output unit; 908-storage unit; and 909-communication unit.

### DETAILED DESCRIPTION

For clearer descriptions of the technical features, objectives, and the technical effects of the embodiments of the present disclosure, the specific embodiments of the present disclosure are hereinafter described with reference to the accompanying drawings.

In this text, the term “exemplary” is used herein to mean “serving as an example, instance, or illustration,” and any illustration or embodiment described herein as “exemplary” shall not be necessarily construed as preferred or advantageous over other illustrations or embodiments.

For brevity, parts relevant to the present disclosure are merely illustrated in the drawings, and these parts do not denote the actual structure of the product. In addition, for brevity and ease of understanding, with respect to parts having the same structure or function in the drawings, one or more of these parts are illustratively drawn in the drawings, or one or more of these parts are marked.

A conventional swimming pool cleaning robot, during performing a cleaning task, fails to reasonably plan a cleaning path, thereby causing problems that a long time for the cleaning robot is taken to clean a swimming pool, cleaning coverage is insufficient, power consumption for the cleaning is large, and the like. Accordingly, the present disclosure provides an improved method and apparatus for cleaning a swimming pool, and an electronic device and a computer storage medium thereof, which may solve the problems in the related art.

The specific embodiments of the present disclosure are described in detail hereinafter with reference to the accompanying drawings.

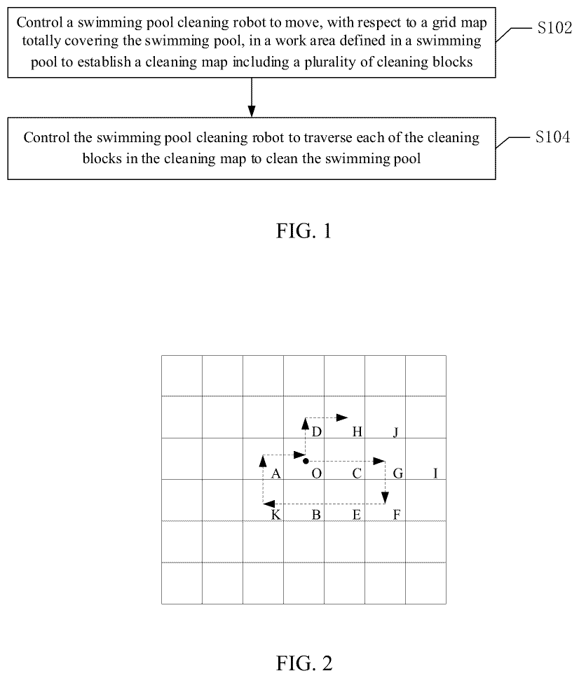

FIG. 1 is a schematic flowchart of a method for cleaning a swimming pool according to one exemplary embodiment of the present disclosure. As illustrated in FIG. 1, this embodiment mainly includes the following steps:

In step S102, a swimming pool cleaning robot is controlled to move, with respect to a grid map covering the swimming pool, in a work area defined in a swimming pool to establish a cleaning map including a plurality of cleaning blocks.

Optionally, the grid map may be constructed by M×N grid blocks.

Optionally, the grid map may be a pre-configured grid map, for example, a grid map generated according to predetermined map parameters, wherein the predetermined map parameters may be fixed parameters or adjustable parameters.

Optionally, the grid map may be a grid map generated in real time according to a man-machine interaction result. For example, corresponding map parameters may be determined according to a region range (for example, a region range delineated in a drawing fashion) input by a user, and the grid map is generated according to the corresponding map parameters. Still for example, the corresponding map parameters may be determined according to information including an area, shape, position, and the like input by the user, and the grid map is generated according to the corresponding map parameters.

Optionally, the corresponding map parameters may be determined according to images of the swimming pool (for example, two-dimensional area images or three-dimensional volume images of the swimming pool) captured by an image capture device, and the grid map is generated according to the corresponding map parameters.

Optionally, the grid map covering the swimming pool may be generated according to an initial position and an initial orientation of the swimming pool cleaning robot.

Specifically, a predetermined central point may be determined according to the initial position of the swimming pool cleaning robot, and the grid map of the swimming pool covering the work area in the swimming pool may be generated according to the predetermined central point.

In one embodiment, the initial position and the initial orientation of the swimming pool cleaning robot may be determined according to a position and an orientation at a bottom of the swimming pool to which the swimming pool cleaning robot freely sinks. Specifically, the position and the orientation of the swimming pool cleaning robot at the bottom of the swimming pool to which the swimming pool cleaning robot freely sinks when being placed into the swimming pool are determined as the initial position and the initial orientation of the swimming pool cleaning robot.

In another embodiment, the swimming pool cleaning robot is also controlled to move, in response to a move instruction, to a designated position and a designated orientation with respect to the swimming pool, and the designated position and the designated orientation are determined as the initial position and the initial orientation of the swimming pool cleaning robot. Specifically, in the case that the swimming pool cleaning robot freely sinks to the bottom of the swimming pool, the swimming pool cleaning robot may be controlled to move, in response to the move instruction, to the designated position and the designated orientation expected by a user with respect to the bottom of the swimming pool, and the initial position and the initial orientation of the swimming pool cleaning robot are determined according to the designated position and the designated orientation.

Optionally, referring to FIG. 2, the grid map generated according to this embodiment includes a plurality of grid blocks (for example, grid blocks A, B, C, D, O, and the like).

In this embodiment, a size (that is, a length and a width of the grid block) of each of the grid blocks in the grid map may be determined on the basis of a predetermined stepping distance of the swimming pool cleaning robot.

In this embodiment, the predetermined stepping distance of the swimming pool cleaning robot may be generated on the basis of dimensions (for example, a length and a width of the swimming pool cleaning robot) of the swimming pool cleaning robot.

Optionally, the initial position of the swimming pool cleaning robot may be determined as central point coordinates of the grid map, and block coordinates of each of the grid blocks may be generated according to the central point coordinates.

Optionally, the swimming pool cleaning robot is controlled to move, with respect to the grid map, in the work area defined in the swimming pool to determine the plurality of cleaning blocks in the grid map; and the cleaning map is established according to the plurality of cleaning blocks determined in the grid map.

Specifically, the work area (a cleaning region) of the swimming pool cleaning robot may be defined according to a water region of the swimming pool, and in combination with a predetermined map establishment movement algorithm and a predetermined path-finding algorithm, the swimming pool cleaning robot is controlled to move, with respect to grid blocks in the grid map, in the work area, and grid blocks reachable by the swimming pool cleaning robot in the grid map are determined as the cleaning blocks.

In step S104, the swimming pool cleaning robot is controlled to traverse each of the cleaning blocks in the cleaning map to clean the swimming pool.

Optionally, in combination with a predetermined cleaning movement algorithm and the predetermined path-finding algorithm, the swimming pool cleaning robot may be controlled to traverse each of the cleaning blocks in the cleaning map.

In summary, in the method according to this embodiment, the swimming pool cleaning robot is controlled to move, with respect to each of the grid blocks in the grid map, in the work area defined in the swimming pool to determine the cleaning blocks in the grid map, and the determined cleaning blocks may accurately reflect a shape and a size of the work area in the swimming pool. Therefore, by controlling the swimming pool cleaning robot to traverse the cleaning blocks, cleaning coverage of the swimming pool cleaning robot in the swimming pool may be improved, and safety and success rate of the swimming pool cleaning robot in performing a swimming pool cleaning task are also enhanced.

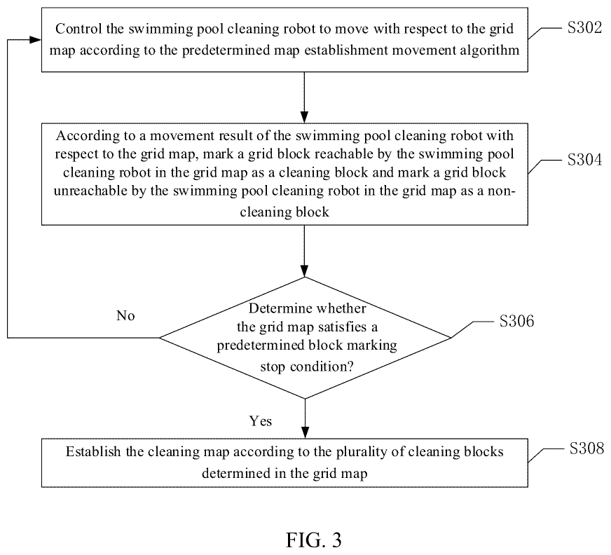

FIG. 3 is a schematic flowchart of a method for cleaning a swimming pool according to another exemplary embodiment of the present disclosure. This embodiment illustrates a specific implementation solution of step S102. As illustrated in FIG. 3, this embodiment mainly includes the following steps:

In step S302, the swimming pool cleaning robot is controlled to move with respect to the grid map according to the predetermined map establishment movement algorithm.

In this embodiment, the predetermined map establishment movement algorithm includes: moving forward on the basis of a current orientation of the swimming pool cleaning robot; and in response to a failure to move forward on the basis of the current orientation of the swimming pool cleaning robot, moving forward after performing a steering operation on the basis of the current orientation of the swimming pool cleaning robot and a predetermined rotation angle, or moving backward on the basis of the current orientation of the swimming pool cleaning robot.

Optionally, the predetermined rotation angle includes a 90-degree clockwise rotation angle (a 90-degree rightward rotation angle) or a 90-degree counterclockwise rotation angle (a 90-degree leftward rotation angle) on the basis of the current orientation of the swimming pool cleaning robot.

For example, in the case that the predetermined rotation angle is +90 degrees, the swimming pool cleaning robot is rotated clockwise by 90 degrees on the basis of the current orientation thereof; and in the case that the predetermined rotation angle is-90 degrees, the swimming pool cleaning robot is rotated counterclockwise by 90 degrees on the basis of the current orientation thereof.

For example, in the case that the swimming pool cleaning robot is located in the grid block O illustrated in FIG. 2 and faces towards the grid block D, the swimming pool cleaning robot may move forward along a direction of a dotted-line arrow in FIG. 2. In the case that the swimming pool cleaning robot moves to a grid block G and fails to move forward any further, the swimming pool cleaning robot may be rotated clockwise by 90 degrees on the basis of the current orientation thereof, such that the orientation of the swimming pool cleaning robot is changed from facing towards a grid block I to facing towards a grid block F, and the swimming pool cleaning robot continues to move towards the grid block F; or the swimming pool cleaning robot may be rotated counterclockwise by 90 degrees on the basis of the current orientation thereof, such that the orientation of the swimming pool cleaning robot is changed from facing towards the grid block I to a grid block J, and the swimming pool cleaning robot continues to move towards the grid block J; or additionally, the swimming pool cleaning robot may move backward on the basis of the current orientation thereof, and move backward from the grid block G to the grid block C.

In step S304, according to a movement result of the swimming pool cleaning robot with respect to the grid map, a grid block reachable by the swimming pool cleaning robot in the grid map is marked as a cleaning block and a grid block unreachable by the swimming pool cleaning robot in the grid map as is marked a non-cleaning block.

Specifically, the grid block reachable by the swimming pool cleaning robot in the grid map may correspond to the work area (for example, the water region in the swimming pool) in the swimming pool, and in this case, the grid block may be marked as the cleaning block; and on the contrary, the grid block unreachable by the swimming pool cleaning robot in the grid map may correspond to a non-work area (for example, an obstacle in the swimming pool or a wall of the swimming pool) in the swimming pool, and in this case, the grid block may be marked as the non-cleaning block.

In step S306, whether the grid map satisfies a predetermined block marking stop condition is determined. The process returns to step S302 in the case that the grid map does not satisfy the predetermined block marking stop condition, and step S308 is performed in the case that the grid map satisfies the predetermined block marking stop condition.

Optionally, in the case that all the block blocks adjacent to each of the cleaning blocks are marked, a determination result indicating whether the grid map satisfies the predetermined block marking stop condition may be acquired.

In step S308, the cleaning map is established according to the plurality of cleaning blocks determined in the grid map.

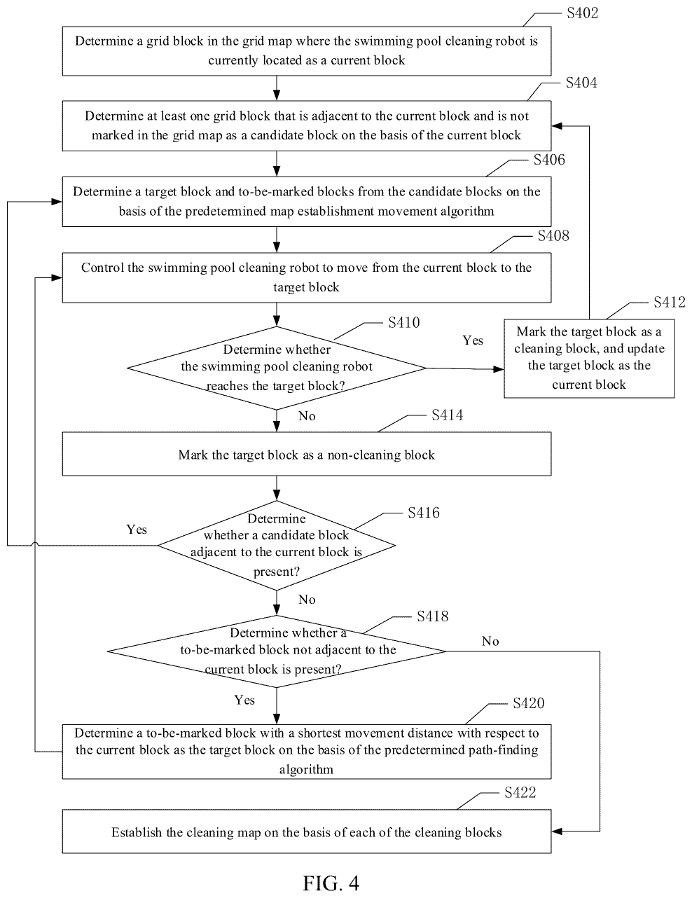

FIG. 4 is a schematic flowchart of a method for cleaning a swimming pool according to another exemplary embodiment of the present disclosure. This embodiment illustrates a specific implementation solution of step S302 (or step S102). As illustrated in FIG. 4, this embodiment mainly includes the following steps:

In step S402, a grid block in the grid map, where the swimming pool cleaning robot is currently located, is determined as a current block.

In this embodiment, the grid block of the initial position of the swimming pool cleaning robot in the case that the swimming pool cleaning robot falls at the bottom of the swimming pool is first determined as the current block, and during the subsequent map establishment process, the current block in the grid map is updated according to the grid block where the swimming pool cleaning robot is actually and currently located.

In step S404, at least one grid block that is adjacent to the current block and is not marked in the grid map is determined as a candidate block on the basis of the current block.

In this embodiment, since the grid map is generated on the basis of the initial position and the initial orientation of the swimming pool cleaning robot, the candidate block determined on the basis of the current block is inevitably located to the right front, right back, front left, or front right of the swimming pool cleaning robot.

Exemplarily, referring to the grid map illustrated in FIG. 2, assuming that the swimming pool cleaning robot is currently located at the grid block O, then the grid block O is determined as the current block, and according to the current block O, the grid blocks that are adjacent to the current block O and are not marked may be found from the grid map including grid blocks A, B, C, and D. In this case, these grid blocks A, B, C, and D are all determined as the candidate blocks.

In step S406, a target block and to-be-marked blocks are determined from the candidate blocks on the basis of the predetermined map establishment movement algorithm.

Optionally, in the case that only one candidate block is adjacent to the current block, this unique candidate block is the target block; and in the case that a plurality of candidate blocks are adjacent to the current block, one candidate block may be determined from the candidate blocks as the target block on the basis of the predetermined map establishment movement algorithm.

Optionally, a movement path or a time consumption for movement of the swimming pool cleaning robot from the current block to each of the candidate blocks may be determined on the basis of the predetermined map establishment movement algorithm of the swimming pool cleaning robot, and a candidate block with a shortest movement path or a least time consumption for movement is determined as the target block according to the movement path or the time consumption for movement from the current block to each of the candidate blocks.

Exemplarily, referring to FIG. 2, in the case that the current block is the grid block O and the grid blocks A, B, C, and D are all the candidate blocks, assuming that the swimming pool cleaning robot currently faces towards the grid block C, then the swimming pool cleaning robot only needs to move forward, that is, move from the grid block O to the grid block C; or, the swimming pool cleaning robot may rotate clockwise by 90 degrees (rotate to the right by 90 degrees) and move forward, to move from the grid block O to the grid block B; or, the swimming pool cleaning robot may rotate counterclockwise by 90 degrees (rotate to the left by 90 degrees) and move forward, to move from the grid block O to the grid block D; or, the swimming pool cleaning robot may consecutively rotate clockwise twice each by 90 degrees (rotate to the right twice each by 90 degrees) or rotate counterclockwise twice each by 90 degrees (rotate to the left twice each by 90 degrees) and move forward, to move from the grid block O to the grid block A; or the swimming pool cleaning robot may move backward, to move from the grid block O to the grid block A.

Generally, in the case that the swimming pool cleaning robot makes a turn during movement, the corresponding movement path of the swimming pool cleaning robot is relatively longer or the corresponding time consumption for movement is relatively more. As such, since there is no turn in movement from the grid block O to the grid block B, the corresponding movement path is the shortest or the corresponding time consumption for movement is the least, and in this case, the grid block B may be determined as the target block.

Exemplarily, in the case that the current block is the grid block G, and the grid blocks F and J are both the candidate blocks (that is, the grid blocks that are adjacent to the grid block G and are not marked), assuming that the swimming pool cleaning robot currently faces towards the grid block I, then the swimming pool cleaning robot may rotate clockwise by 90 degrees (rotate to the right by 90 degrees) and move forward, to move from the grid block G to the grid block F; or, the swimming pool cleaning robot may rotate counterclockwise by 90 degrees (rotate to the left by 90 degrees) and move forward, to move from the grid block G to the grid block J. Since the movement path and the time consumption for movement from the grid block G to the grid block F are equal to the movement path and the time consumption for movement from the grid block G to the grid block J, any of the grid block F and the grid block J may be determined as the target block.

Optionally, the target block may be determined from the candidate blocks with the equal movement path and the time consumption for movement on the basis of a preferential rotation direction of the swimming pool cleaning robot.

For example, in the case that the preferential rotation direction of the swimming pool cleaning robot is the right, the grid block F may be determined as the target block of the grid block G (the current block).

Optionally, in the case that a plurality of candidate blocks adjacent to the current block are present, all the other candidate blocks other than the target block in the plurality of candidate blocks may be determined as the to-be-marked blocks.

Exemplarily, referring to FIG. 2, in the case that the current block is the grid block O, and the grid blocks A, B, C, and D are all the candidate blocks, assuming that the grid block C is determined as the target block on the basis of the predetermined map establishment movement algorithm, then, the grid blocks A, B, and D are all determined as the to-be-marked blocks.

In step S408, the swimming pool cleaning robot is controlled to move from the current block to the target block.

In this embodiment, in the case that the target block is determined on the basis of the predetermined map establishment movement algorithm, likewise, the swimming pool cleaning robot is driven to move from the current block to the target block on the basis of the movement path generated by the predetermined map establishment movement algorithm.

Exemplarily, referring to FIG. 2, assuming that the swimming pool cleaning robot currently faces towards the grid block C, then the swimming pool cleaning robot may move forward, to move from the grid block O to the grid block C; or, the swimming pool cleaning robot may move clockwise by 90 degrees (rotate to the right by 90 degrees) and move forward, to move from the grid block O to the grid block B. For the specific movement of the swimming pool cleaning robot, reference may be made to the description of step S406, which is not described herein any further.

In step S410, whether the swimming pool cleaning robot reaches the target block is determined. In the case that the swimming pool cleaning robot reaches the target block, step S412 is performed; and in the case that the swimming pool cleaning robot fails to reach the target block, step S414 is performed.

In this embodiment, the swimming pool cleaning robot may be controlled to perform a collision detection with respect to the target block, to determine whether the target block corresponds to the water region in the swimming pool, and determine, based on a collision detection result, whether the swimming pool cleaning robot is capable of reaching the target block.

In step S412, the target block is marked as a cleaning block, and the target block is updated as the current block.

Specifically, in the case that the swimming pool cleaning robot is capable of reaching the target block, the target block corresponds to the water region in the swimming pool, and the target block is marked as the cleaning block. In the case that the swimming pool cleaning robot reaches the target block, the target block is updated as the current block, and the process returns to step S404.

In step S414, the target block is marked as a non-cleaning block.

In this embodiment, in the case that the swimming pool cleaning robot fails to reach the target block, the target block corresponds to a wall of the swimming pool or an obstacle in the swimming pool, and in this case, the target block is marked as a non-cleaning block.

In step S416, whether a candidate block adjacent to the current block is present is determined. The process returns to step S406 in the case that a candidate block adjacent to the current block is present, and step S418 is performed in the case that no candidate block adjacent to the current block is present.

Optionally, whether other candidate blocks (or referred to as to-be-marked blocks adjacent to the current block) are present may be determined. In the case that other candidate blocks adjacent to the current block are present, the process returns to step S406 to determine a next target block to be moved.

Exemplarily, referring to FIG. 2, in the case that the current block is the grid block G, assuming that the target block I is a non-cleaning block, then whether candidate blocks (or referred to as to-be-marked block adjacent to the current block G) adjacent to the current block G are present is determined. In the case that it is determined that the candidate blocks (or referred to as the to-be-marked blocks) adjacent to the current block G include the grid blocks J and F, the process returns to step S406 to determine a next target block to be moved on the basis of the predetermined map establishment movement algorithm.

In step S418, whether a to-be-marked block not adjacent to the current block is present is determined. Step S420 is performed in the case that a candidate block not adjacent to the current block is present, and step S422 is performed in the case that no such a candidate block is present.

In this embodiment, whether a to-be-marked block not adjacent to the current block is present in the grid map may be determined. In the case that a determination result indicates that no such a block is present, all the grid blocks adjacent to each of the cleaning blocks in the grid map have been marked. In this case, the cleaning map has been established, and this step may be skipped.

In step S420, a to-be-marked block with a shortest movement distance with respect to the current block is determined as the target block on the basis of the predetermined path-finding algorithm.

In this embodiment, the to-be-marked block with the shortest movement distance with respect to the current block may be determined on the basis of the A-STAR algorithm, and the processor returns to step S408 to control the swimming pool cleaning robot to move from the current block to the target block.

It should be noted that, in the case that the target block is determined on the basis of the predetermined path-finding algorithm, in step S408, the swimming pool cleaning robot is driven to move from the current block to the target block on the basis of the movement path determined on the basis of the predetermined path-finding algorithm.

In step S422, the cleaning map is established on the basis of each of the cleaning blocks.

Optionally, the cleaning map corresponding to the work area (the water region) in the swimming pool may be established on the basis of all the cleaning blocks marked in the grid map.

Optionally, the cleaning map corresponding to the work area (for example, the water region in the swimming pool) and the non-work area (for example, the walls in the swimming pool) in the swimming pool may also be established on the basis of all the cleaning blocks and all the non-cleaning blocks that are marked in the grid map.

In summary, with the method for cleaning the swimming pool according to the embodiments illustrated in FIG. 3 and FIG. 4, in combination with the predetermined map establishment movement algorithm and the predetermined path-finding algorithm, the swimming pool cleaning robot is controlled to move with respect to the grid map, and the grid blocks in the grid map are marked, such that the generated cleaning map accurately reflects the shape and size of the work area in the swimming pool, thereby achieving the advantages of less time consumption and high accuracy in map establishment.

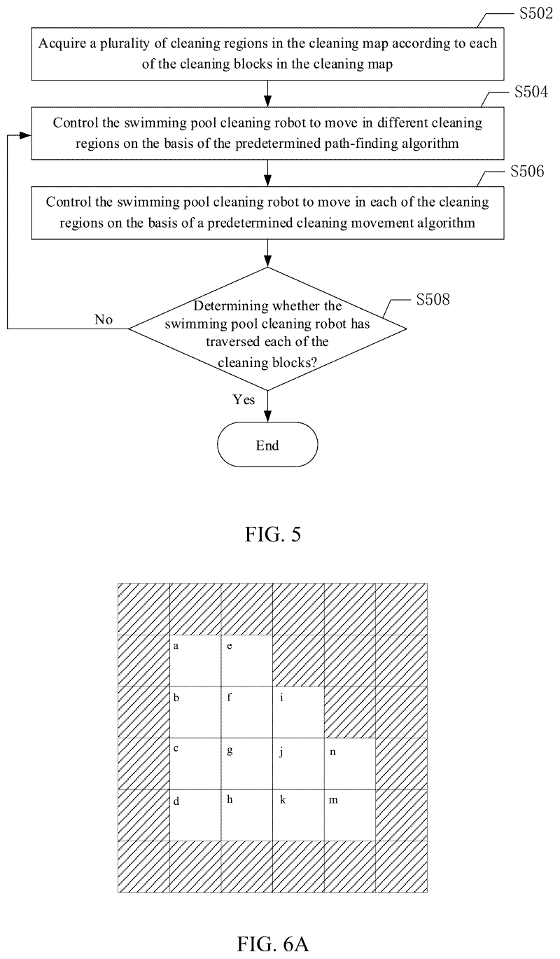

FIG. 5 is a schematic flowchart of a method for cleaning a swimming pool according to another exemplary embodiment of the present disclosure. This embodiment illustrates one specific implementation solution of step S104. As illustrated in FIG. 5, this embodiment mainly includes the following steps:

In step S502, a plurality of cleaning regions in the cleaning map are acquired according to each of the cleaning blocks in the cleaning map.

Optionally, a non-contiguous single cleaning block in the cleaning map may be identified, and a cleaning region including the single cleaning block may be acquired.

Optionally, a plurality of cleaning blocks that are in a same row or column and contiguous in the cleaning map may be identified, and a cleaning region including the plurality of cleaning blocks may be acquired.

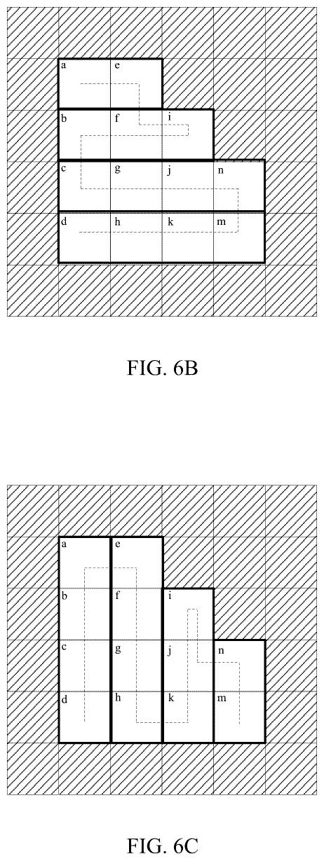

Referring to FIG. 6A to FIG. 6C, FIG. 6A schematically illustrates the cleaning map established according to the embodiment illustrated in FIG. 2 or FG. 4.

In one embodiment, a plurality of cleaning blocks that are in the same row and contiguous in the cleaning map may be identified, and a plurality of cleaning regions corresponding to various rows may be generated (referring to FIG. 6B). Specifically, a cleaning region corresponding to a first row may be generated according to cleaning blocks a and e in the first row; a cleaning region corresponding to a second row may be generated according to cleaning blocks b, f, and i in the second row; a cleaning region corresponding to a third row may be generated according to cleaning blocks c, g, j, and 1; and a cleaning region corresponding to a fourth row may be generated according to cleaning blocks d, h, k, and m in the fourth row.

In one embodiment, a plurality of cleaning blocks that are in the same column and contiguous in the cleaning map may be identified, and a plurality of cleaning regions corresponding to various columns may be generated (referring to FIG. 6C). Specifically, a cleaning region corresponding to a first column may be generated according to cleaning blocks a, b, c, and d in the first column; a cleaning region corresponding to a second column may be generated according to cleaning blocks e, f, g, and h in the second column; a cleaning region corresponding to a third column may be generated according to cleaning blocks i, j, and k; and a cleaning region corresponding to a fourth column may be generated according to cleaning blocks n and m in the fourth column.

In this embodiment, each of the generated cleaning regions may include two region endpoints, wherein the two region endpoints of a cleaning region may be determined by the cleaning blocks at two ends of the cleaning region.

For example, using the cleaning regions in FIG. 6B as examples, the two region endpoints corresponding to the cleaning region in the third row are the cleaning block c and the cleaning block m.

Still for example, using the cleaning regions in FIG. 6C as examples, the two region end points corresponding to the cleaning region in the first column are the cleaning block a and the cleaning block d.

Optionally, block coordinates of each of the cleaning blocks in the cleaning map may be determined according to block coordinates of each of the grid blocks, and endpoint coordinates of two region endpoints of a cleaning region may be determined according to block coordinates of two cleaning blocks at the two ends of the cleaning region.

Optionally, the block coordinates corresponding to each of the cleaning blocks may be relative coordinates in a relative coordinate system established on the basis of the cleaning map or the grid map, or may be absolute coordinates (for example, longitude and latitude coordinates) in an absolute coordinate system.

In step S504, the swimming pool cleaning robot is controlled to move in different cleaning regions on the basis of the predetermined path-finding algorithm.

Optionally, according to region endpoints of a cleaning region where the swimming pool cleaning robot is currently located, and two region endpoints of each of cleaning regions that are not cleaned in the cleaning map, a region endpoint having a shortest movement distance from the swimming pool cleaning robot may be determined as a target endpoint on the basis of the predetermined path-finding algorithm, and a cleaning region including the target endpoint may be determined as a cleaning region to be cleaned by the swimming pool cleaning robot.

Optionally, the predetermined path-finding algorithm may include, but is not limited to, the A-STAR algorithm. Instead, other path-finding algorithms may also be employed, which is not limited in the present disclosure.

Exemplarily, in the case that the swimming pool cleaning robot is currently located in the cleaning block e in the cleaning region corresponding to the first row in FIG. 6B, according the two region endpoints of each of cleaning regions that are not cleaned in the cleaning map, the region endpoint having the shortest movement distance from the swimming pool cleaning robot is determined as the cleaning block i, and the cleaning block i is determined as the target endpoint, and the cleaning region (the cleaning region corresponding to the second row) including the cleaning block i is determined as the cleaning region to be cleaned by the swimming pool cleaning robot.

Exemplarily, in the case that the swimming pool cleaning robot is currently located in the cleaning block h in the cleaning region corresponding to the second column in FIG. 6C, according the two region endpoints of each of cleaning regions that are not cleaned in the cleaning map, the region endpoint having the shortest movement distance from the swimming pool cleaning robot is determined as the cleaning block k, and the cleaning block k is determined as the target endpoint, and the cleaning region (the cleaning region corresponding to the third column) including the cleaning block k is determined as the cleaning region to be cleaned by the swimming pool cleaning robot.

Optionally, on the basis of the predetermined path-finding algorithm, the swimming pool cleaning robot may be controlled to move towards the target endpoint to move from the cleaning region where the swimming pool cleaning robot is currently located to the cleaning region to be cleaned, and step S506 is performed in response to updating the cleaning region to be cleaned as the cleaning region where the swimming pool cleaning robot is currently located.

Specifically, on the basis of the movement path generated by the predetermined path-finding algorithm (for example, the A-STAR algorithm), the swimming pool cleaning robot may be controlled to move towards the target endpoint to move from the cleaning region where the swimming pool cleaning robot is currently located to the cleaning region to be cleaned.

In step S506, the swimming pool cleaning robot is controlled to move in each of the cleaning regions on the basis of a predetermined cleaning movement algorithm.

Optionally, one region endpoint matching the target endpoint in the two region endpoints of the cleaning region where the swimming pool cleaning robot is currently located may be determined as a starting endpoint, and the other region endpoint in the two region endpoints may be determined as an ending endpoint; and the swimming pool cleaning robot may be controlled to move from the starting endpoint to the ending endpoint to traverse each of the cleaning blocks in the cleaning regions.

For example, in the case that the target endpoint is the cleaning block i in FIG. 6B, according to the two region endpoints of the cleaning region corresponding to the second row, that is, the cleaning block i and the cleaning block b, the cleaning block i is determined as the starting endpoint and the cleaning block b is determined as the ending endpoint, to drive the swimming pool cleaning robot to move from the cleaning block i to the cleaning block b. In this way, the swimming pool cleaning robot traverses each of the cleaning blocks in the cleaning region corresponding to the second row.

In step S508, whether the swimming pool cleaning robot has traversed each of the cleaning blocks in the cleaning map is determined. The process ends in the case that the swimming pool cleaning robot has traversed each of the cleaning blocks, and the process returns to S504 in the case that the swimming pool cleaning robot has not traversed each of the cleaning blocks.

It should be noted that the sequence of performing step S504 and step S506 in this embodiment is not strictly limited. To be specific, step S502 may be performed first, and then step S506 may be performed; or these two steps may be alternately and repeated performed until the swimming pool cleaning robot traverses each of the cleaning blocks in the cleaning map.

For example, in the case that the cleaning regions in the cleaning map are generated in step S502, step S506 is performed first to, determine, according to the two region endpoints of the cleaning region where the swimming pool cleaning robot is currently located, one region endpoint having the shortest movement distance from the swimming pool cleaning robot in the two region endpoints as the starting endpoint and determine the other endpoint in the two region endpoints as the ending endpoint, to drive the swimming pool cleaning robot to perform a cleaning task in the cleaning region where the swimming pool cleaning robot is currently located. Upon completion of the cleaning, step S504 is performed.

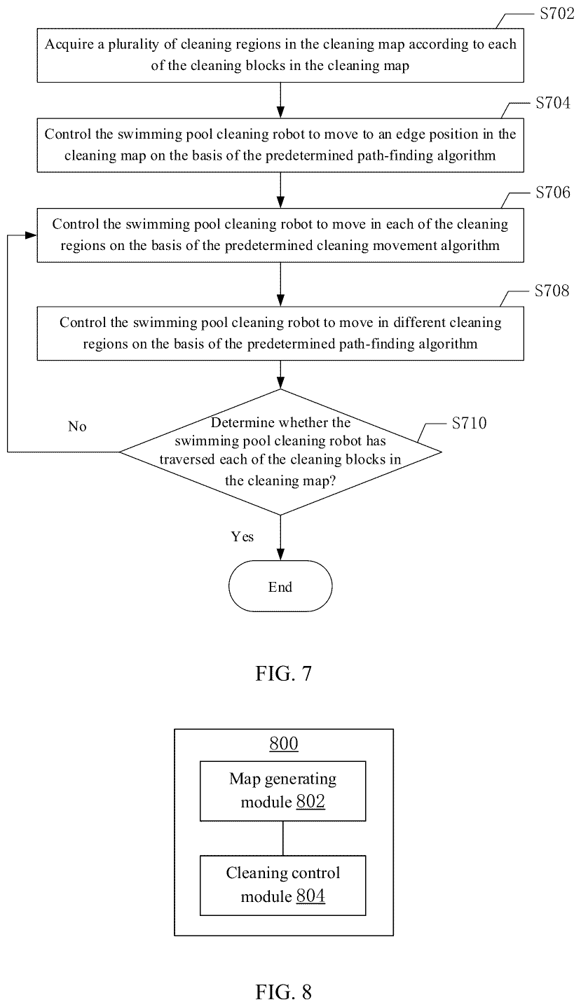

FIG. 7 is a schematic flowchart of a method for cleaning a swimming pool according to another exemplary embodiment of the present disclosure. This embodiment illustrates another specific implementation solution of step S104. As illustrated in FIG. 7, this embodiment mainly includes the following steps:

In step S702, a plurality of cleaning regions in the cleaning map are acquired according to each of the cleaning blocks in the cleaning map.

Optionally, a non-contiguous single cleaning block in the cleaning map may be identified, and a cleaning region including the single cleaning block may be acquired.

Optionally, a plurality of cleaning blocks that are in a same row or column and contiguous in the cleaning map may be identified, and a cleaning region including the plurality of cleaning blocks may be acquired.

For the specific method for generating the cleaning regions in the cleaning map, reference may be made to the description in step S502, which is not described herein any further.

In step S704, the swimming pool cleaning robot is controlled to move to an edge position in the cleaning map on the basis of the predetermined path-finding algorithm.

Optionally, according to a cleaning block in the cleaning map where the swimming pool cleaning robot is currently located, and two region endpoints of each of cleaning regions that are not cleaned in the cleaning map, a region endpoint that has a shortest movement distance from the swimming pool cleaning robot and located at an edge position of the cleaning map is determined as a target endpoint on the basis of the predetermined path-finding algorithm, and a cleaning region including the target endpoint is determined as a cleaning region to be cleaned by the swimming pool cleaning robot; and the swimming pool cleaning robot is controlled to move towards the target endpoint on the basis of the predetermined path-finding algorithm, the cleaning region to be cleaned is updated as the cleaning region where the swimming pool cleaning robot is currently located in response to reaching the target endpoint, and step S706 is performed.

For example, in the case that the swimming pool cleaning robot is currently located in the cleaning block g in FIG. 6B, according the two region endpoints of each of cleaning regions that are not cleaned in the cleaning map, the region endpoint that has the shortest movement distance from the swimming pool cleaning robot and located at the edge position in the cleaning map is determined as the cleaning block c. In this case, the cleaning block c may be determined as the target endpoint, the cleaning region (the cleaning region corresponding to the third row in FIG. 6B) including the cleaning block c may be determined as a cleaning region to be cleaned, and the swimming pool cleaning robot may be driven to move from the cleaning block g to the cleaning block c on the basis of the movement path generated by the predetermined path-finding algorithm. In the case that the swimming pool cleaning robot reaches the cleaning block c, the cleaning region corresponding to the third row in FIG. 6B is updated as the cleaning region.

In step S706, the swimming pool cleaning robot is controlled to move in each of the cleaning regions on the basis of the predetermined cleaning movement algorithm.

Optionally, one region endpoint matching the target endpoint in the two region endpoints of the cleaning region where the swimming pool cleaning robot is currently located may be determined as a starting endpoint, and the other region endpoint in the two region endpoints may be determined as an ending endpoint; and the swimming pool cleaning robot may be controlled to move from the starting endpoint to the ending endpoint to traverse each of the cleaning blocks in the cleaning regions.

For the specific cleaning solution in this step, reference may be made to the description in step S506, which is not described herein any further.

In step S708, the swimming pool cleaning robot is controlled to move in different cleaning regions on the basis of the predetermined path-finding algorithm.

Optionally, according to region endpoints of a cleaning region where the swimming pool cleaning robot is currently located, and two region endpoints of each of cleaning regions that are not cleaned in the cleaning map, a region endpoint having a shortest movement distance from the swimming pool cleaning robot may be determined as a target endpoint on the basis of the predetermined path-finding algorithm, and a cleaning region including the target endpoint may be determined as a cleaning region to be cleaned by the swimming pool cleaning robot; and on the basis of the predetermined path-finding algorithm, the swimming pool cleaning robot may be controlled to move towards the target endpoint to move from the cleaning region where the swimming pool cleaning robot is currently located to the cleaning region to be cleaned, and step S710 is performed in response to updating the cleaning region to be cleaned as the cleaning region where the swimming pool cleaning robot is currently located.

For the specific cleaning solution in this step, reference may be made to the description in step S504, which is not described herein any further.

In step S710, whether the swimming pool cleaning robot has traversed each of the cleaning blocks in the cleaning map is determined. The process ends in the case that the swimming pool cleaning robot has traversed each of the cleaning blocks, and the process returns to S706 in the case that the swimming pool cleaning robot has not traversed each of the cleaning blocks.

In summary, according to the embodiment illustrated in FIG. 5 or FIG. 7, a cleaning region including at least one cleaning block may be generated on the basis of the cleaning blocks in the cleaning map, and the swimming pool cleaning robot is controlled to move between the cleaning regions or inside the cleaning regions by using the predetermined path-finding algorithm and the predetermined cleaning movement algorithm, to perform the swimming pool cleaning task. In this way, the swimming pool may be quickly and efficiently cleaned.

FIG. 8 is a schematic structural block diagram of an apparatus for cleaning a swimming pool according to one exemplary embodiment of the present disclosure.

The apparatus 800 according to this embodiment may be mounted in a swimming pool cleaning robot, wherein the swimming pool cleaning robot is applicable to cleaning the swimming pool.

As illustrated in FIG. 8, the apparatus 800 according to this embodiment mainly includes a map generating module 802 and a cleaning control module 804.

The map generating module 802 is configured to control a swimming pool cleaning robot to move, with respect to a grid map covering the swimming pool, in a work area defined in the swimming pool to establish a cleaning map including a plurality of cleaning blocks.

The cleaning control module 804 is configured to control the swimming pool cleaning robot to traverse each of the cleaning blocks in the cleaning map to clean the swimming pool.

Optionally, the map generating module 802 is further configured to: control the swimming pool cleaning robot to move, with respect to the grid map, in the work area defined in the swimming pool to determine the plurality of cleaning blocks in the grid map; and establish the cleaning map according to the plurality of cleaning blocks determined in the grid map.

Optionally, the map generating module 802 is further configured to: perform a moving step of controlling the swimming pool cleaning robot to move with respect to the grid map according to a predetermined map establishment movement algorithm; perform a marking step of marking a grid block reachable by the swimming pool cleaning robot in the grid map as a cleaning block and marking a grid block unreachable by the swimming pool cleaning robot in the grid map as a non-cleaning block, according to a movement result of the swimming pool cleaning robot with respect to the grid map; and alternately perform the moving step and the marking step until the grid map satisfies a predetermined block marking stop condition.

Optionally, a size of each of the grid blocks in the grid map is determined on the basis of a predetermined stepping distance of the swimming pool cleaning robot.

Optionally, the moving step performed by the map generating module 802 includes: determining a grid block in the grid map, where the swimming pool cleaning robot is currently located, as a current block; determining at least one grid block that is adjacent to the current block and is not marked in the grid map as a candidate block on the basis of the current block; and determining a target block in the candidate block on the basis of the predetermined map establishment movement algorithm, and controlling the swimming pool cleaning robot to move from the current block to the target block.

Optionally, the map generating module 802 is further configured to: determine, in when there are a plurality of candidate blocks adjacent to the current block, a candidate block with a shortest movement path with respect to the swimming pool cleaning robot or a least time consumption for movement of the swimming pool cleaning robot in the plurality of candidate blocks as the target block on the basis of the predetermined map establishment movement algorithm, and determine all the other candidate blocks other than the target block in the plurality of candidate blocks as to-be-marked blocks.

Exemplarily, the predetermined map establishment movement algorithm includes: moving forward on the basis of a current orientation of the swimming pool cleaning robot; and in response to a failure to move forward on the basis of the current orientation of the swimming pool cleaning robot, moving forward after performing a steering operation on the basis of the current orientation of the swimming pool cleaning robot and a predetermined rotation angle, or moving backward on the basis of the current orientation of the swimming pool cleaning robot; wherein the predetermined rotation angle includes a 90-degree clockwise rotation angle or a 90-degree counterclockwise rotation angle on the basis of the current orientation of the swimming pool cleaning robot.

Optionally, the map generating module 802 is further configured to: acquire, when there is no candidate block adjacent to the current block, each of the to-be-marked blocks in the grid map; determine a to-be-marked block with a shortest movement distance with respect to the current block as the target block on the basis of a predetermined path-finding algorithm; and control the swimming pool cleaning robot to move from the current block to the target block on the basis of the predetermined path-finding algorithm.

Optionally, the map generating module 802 is further configured to: repeatedly perform the moving step and the marking step until all the grid blocks adjacent to each of the cleaning blocks in the grid map are marked.

Optionally, the cleaning control module 804 is further configured to: acquire a plurality of cleaning regions in the cleaning map according to each of the cleaning blocks in the cleaning map.

Optionally, the cleaning control module 804 is further configured to: identify a non-contiguous single cleaning block in the cleaning map, and acquire a cleaning region including the single cleaning block; or identify a plurality of cleaning blocks that are in a same row or column and contiguous in the cleaning map, and acquire a cleaning region including the plurality of cleaning blocks.

Optionally, the cleaning control module 804 is further configured to: perform an inter-region moving step of controlling the swimming pool cleaning robot to move in different cleaning regions on the basis of the predetermined path-finding algorithm; perform an intra-region moving step of controlling, on the basis of a predetermined cleaning movement algorithm, the swimming pool cleaning robot to move in each of the cleaning regions; and alternately perform the inter-region moving step and the intra-region moving step until the swimming pool cleaning robot traverses each of the cleaning regions in the cleaning map.

Optionally, each of the cleaning regions includes two region endpoints, wherein the region endpoints are determined by the cleaning blocks at two ends of the cleaning region.

Optionally, the cleaning control module 804 is further configured to: determine a region endpoint having a shortest a movement distance from the swimming pool cleaning robot as a target endpoint on the basis of the predetermined path-finding algorithm according to region endpoints of a cleaning region where the swimming pool cleaning robot is currently located, and two region endpoints of each of cleaning regions that are not cleaned in the cleaning map, and determine a cleaning region including the target endpoint as a cleaning region to be cleaned by the swimming pool cleaning robot; and control, on the basis of the predetermined path-finding algorithm, the swimming pool cleaning robot to move towards the target endpoint to move from the cleaning region where the swimming pool cleaning robot is currently located to the cleaning region to be cleaned, and continue to perform the intra-region moving step in response to updating the cleaning region to be cleaned as the cleaning region where the swimming pool cleaning robot is currently located.

Optionally, the cleaning control module 804 is further configured to: determine one region endpoint matching the target endpoint in the two region endpoints of the cleaning region where the swimming pool cleaning robot is currently located as a starting endpoint, and determine the other region endpoint in the two region endpoints as an ending endpoint; and control the swimming pool cleaning robot to move from the starting endpoint to the ending endpoint to traverse each of the cleaning blocks in the cleaning regions, and continue to perform the inter-region moving step.

Optionally, the cleaning control module 804 is further configured to: determine a region endpoint that has a shortest movement distance from the swimming pool cleaning robot and located at an edge position of the cleaning map as a target endpoint on the basis of the predetermined path-finding algorithm according to a cleaning block in the cleaning map where the swimming pool cleaning robot is currently located, and two region endpoints of each of cleaning regions that are not cleaned in the cleaning map, and determine a cleaning region including the target endpoint as a cleaning region to be cleaned by the swimming pool cleaning robot; and control the swimming pool cleaning robot to move towards the target endpoint on the basis of the predetermined path-finding algorithm, update the cleaning region to be cleaned as the cleaning region where the swimming pool cleaning robot is currently located in response to reaching the target endpoint, and continue to perform the intra-region moving step.

Optionally, the predetermined path-finding algorithm includes an A-STAR algorithm.

In addition, the apparatus 800 according to the embodiments of the present disclosure may be employed to perform the other steps of the methods for cleaning the swimming pool as described above, and achieves corresponding beneficial effects that have been achieved by the method embodiments, which are not described herein any further.

An exemplary embodiment of the present disclosure further provides an electronic device. The electronic device includes: at least one processor and a memory communicably connected to the at least one processor. The memory stores a computer program runnable by the at least one processor, wherein the computer program, when run by the at least one processor, causes the electronic device to perform the methods according to the embodiments of the present disclosure.

An exemplary embodiment of the present disclosure further provides a non-transitory computer-readable storage medium storing a computer program therein, wherein the computer program, when run by a processor of a computer, causes the computer to perform the methods according to the embodiments of the present disclosure.

An exemplary embodiment of the present disclosure further provides a computer program product including a computer program therein, wherein the computer program, when run by a processor of a computer, causes the computer to perform the methods according to the embodiments of the present disclosure.

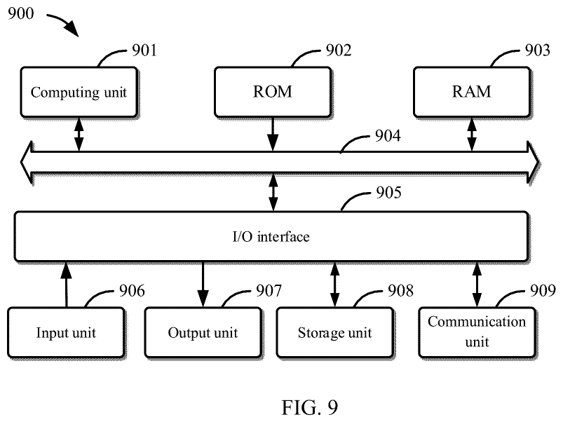

Referring to FIG. 9, a structural block diagram of an electronic device 900 which may serve as a server or a client according to the present disclosure is described, which is an example of a hardware device applicable to various aspects of the present disclosure. The electronic device is intended to represent digital and electronic computer devices in various forms, for example, a laptop computer, a tablet computer, a work station, a personal digital assistance, a server, a blade server, a large-scale computer, and any other suitable computer. The electronic device may also represent mobile devices in various forms, for example, a personal processing device, a cellular phone, a smart phone, a wearable device, and any other similar computing device. The parts or members described in this text, connections and relationships therebetween, and functions thereof are only exemplarily illustrated, instead of causing any limitation to practice described and/or required in this text for the present disclosure.

As illustrated in FIG. 9, the electronic device 900 includes a computing unit 901. The computing unit 901, when running a computer program stored in a read-only memory (ROM) 902 or a computer program loaded from a storage unit 908 to a random-access memory (RAM) 903, is caused to perform suitable actions and operations. The RAM 903 may also store various programs and data desired by the operations of the electronic device 900. The computing unit 901, the ROM 902 and the RAM 903 are connected to each other via a bus 904. An input/output (I/O) interface 905 is also connected to the bus 904.

A plurality of units in the electron device 900 are connected to the I/O interface 905. The units include an input unit 906, an output unit 907, a storage unit 908, and a communication unit 909. The input unit 906 may be any type of device capable of inputting information into the electronic device 900. The input unit 906 may receive input digital or character information and generate key signal inputs related to user settings and/or function control of the electronic device. The output unit 907 may be any type of device capable of displaying information. The output unit 907 may include, but is not limited to, a display, a loudspeaker, a video/audio output terminal, a vibrator, and/or a printer. The storage unit 904 may include, but is not limited to, a magnetic disk and an optical disk. The communication unit 909 allows the electronic device 900 to exchange information/data with other devices over a computer network, for example, the Internet, and/or various telecommunication networks. The communication unit 909 may include, but is not limited to, a modem, a network card, an infrared communication device, a wireless communication transceiver, and/or a chip set, for example, a Bluetooth™ device, a Wi-Fi device, a WiMAX device, a cellular communication device, and/or analogs.

The computing unit 901 may be any universal and/or dedicated processing component having processing and computing capabilities. Some examples of the computing unit 901 include, but are not limited to, a central processing unit (CPU), a graphics processing unit (GPU), any dedicated Artificial Intelligence (AI) computing chip, any computing unit running a machine learning model algorithm, a digital signal processor (DSP), and any suitable processor, controller, micro controller unit, or the like. The computing unit 901 performs the methods and operations as described above. For example, in some embodiments, the methods for cleaning the swimming pool as described in the above embodiments may be practiced as a computer software program, which is tangibly embodied in a machine-readable medium, for example, the storage unit 908. In some embodiments, some or all of the computer programs may be loaded and/or installed onto the electronic device 900 via the ROM 902 and/or the communication unit 909. In some embodiments, the computing unit 901 may be configured, in any suitable fashion (for example, by virtue of firmware), to perform the method for cleaning the swimming pool.

Program codes for implementing the method of the present disclosure may be written in any combination of one or more programming languages. These program codes may be provided to a processor or controller of a general purpose computer, special purpose computer or other programmable data processing apparatus such that the program codes, when executed by the processor or controller, enable the functions/operations specified in the flowcharts and/or block diagrams being implemented. The program codes may be executed entirely on the machine, partly on the machine, as a stand-alone software package partly on the machine and partly on the remote machine, or entirely on the remote machine or server.

In the context of the present disclosure, the machine-readable medium may be a tangible medium that may contain or store programs for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine readable storage medium may include an electrical connection based on one or more wires, a portable computer disk, a hard disk, a RAM, a ROM, an erasable programmable read-only memory (EPROM or a flash memory), an optical fiber, a portable compact disk read-only memory (CD-ROM), an optical storage device, a magnetic storage device, or any suitable combination thereof.

As used herein, the term “machine-readable medium” and “computer-readable medium” refer to any computer program product, apparatus and/or device, for example, a magnetic disk, an optical disk, a memory, and a programmable logic device (PLD), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, one or more aspects or features of the subject matter described herein can be implemented on a computer having a display device, for example a cathode ray tube (CRT) or a liquid crystal display (LCD) or a light emitting diode (LED) monitor for displaying information to the user and a keyboard and a pointing device, for example a mouse or a trackball, by which the user may provide input to the computer. Other types of devices may be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of the communication network include a local area network (LAN), a wide area network (WAN), and the Internet.

The computer system may include a client and a server. The client and the server are deployed distally from each other, and generally communicate and interact with each other over a communication network. The relationship of client and server arises by virtue of computer programs running on the respective computers and having a client-server relationship to each other.

It should be understood that, although this specification is described based on the embodiments, not each of the embodiments discloses an independent technical solution. Such description manner of the specification is only for clarity. A person skilled in the art should consider the specification as an entirety. The technical solutions according to the embodiments may also be suitably combined to derive other embodiments that may be understood by a person skilled in the art.

Described above are merely exemplary specific embodiments of the present disclosure, instead of causing any limitation to the scope of the embodiments of the present disclosure. Any person skilled in the art would derive equivalent variations, modifications, and combinations without departing from the concept and principle of the embodiments of the present disclosure, and these variations, modifications, and combinations shall fall within the scope of projection of the embodiments of the present disclosure.

1. A method for cleaning a swimming pool, comprising:
controlling a swimming pool cleaning robot to move, with respect to a grid map covering the swimming pool, in a work area defined in the swimming pool to establish a cleaning map comprising a plurality of cleaning blocks; and
controlling the swimming pool cleaning robot to traverse each of the cleaning blocks in the cleaning map to clean the swimming pool.

2. The method according to claim 1, wherein the controlling the swimming pool cleaning robot to move, with respect to the grid map covering the swimming pool, in the work area defined in the swimming pool to establish the cleaning map comprising the plurality of cleaning blocks comprises:
controlling the swimming pool cleaning robot to move, with respect to the grid map, in the work area defined in the swimming pool to determine the plurality of cleaning blocks in the grid map; and
establishing the cleaning map according to the plurality of cleaning blocks determined in the grid map.

3. The method according to claim 2, wherein the controlling the swimming pool cleaning robot to move, with respect to the grid map, in the work area defined in the swimming pool to determine the plurality of cleaning blocks in the grid map comprises:
a moving step of controlling the swimming pool cleaning robot to move with respect to the grid map according to a predetermined map establishment movement algorithm;
a marking step of marking a grid block reachable by the swimming pool cleaning robot in the grid map as a cleaning block and marking a grid block unreachable by the swimming pool cleaning robot in the grid map as a non-cleaning block, according to a movement result of the swimming pool cleaning robot with respect to the grid map; and
alternately performing the moving step and the marking step until the grid map satisfies a predetermined block marking stop condition.

4. The method according to claim 3, wherein the moving step comprises:
determining a grid block in the grid map where the swimming pool cleaning robot is currently located as a current block;
determining at least one grid block that is adjacent to the current block and is not marked in the grid map as a candidate block on the basis of the current block;
determining a target block in the candidate block on the basis of the predetermined map establishment movement algorithm; and
controlling the swimming pool cleaning robot to move from the current block to the target block.

5. The method according to claim 4, wherein the determining the target block in the candidate block on the basis of the predetermined map establishment movement algorithm comprises:
determining, when there are a plurality of candidate blocks adjacent to the current block, a candidate block with a shortest movement path with respect to the swimming pool cleaning robot or a least time consumption for movement of the swimming pool cleaning robot in the plurality of candidate blocks as the target block on the basis of the predetermined map establishment movement algorithm; and
determining all the other candidate blocks other than the target block in the plurality of candidate blocks as to-be-marked blocks.

6. The method according to claim 3, wherein the predetermined map establishment movement algorithm comprises:
moving forward on the basis of a current orientation of the swimming pool cleaning robot; and
in response to a failure to move forward on the basis of the current orientation of the swimming pool cleaning robot, moving forward after performing a steering operation on the basis of the current orientation of the swimming pool cleaning robot and a predetermined rotation angle, or moving backward on the basis of the current orientation of the swimming pool cleaning robot,
wherein the predetermined rotation angle comprises a 90-degree clockwise rotation angle or a 90-degree counterclockwise rotation angle on the basis of the current orientation of the swimming pool cleaning robot.

7. The method according to claim 5, further comprising:
acquiring, when there is no candidate block adjacent to the current block, each of the to-be-marked blocks in the grid map;
determining a to-be-marked block with a shortest movement distance with respect to the current block as the target block on the basis of a predetermined path-finding algorithm; and
controlling the swimming pool cleaning robot to move from the current block to the target block on the basis of the predetermined path-finding algorithm.

8. The method according to claim 3, wherein the alternately performing the moving step and the marking step until the grid map satisfies the predetermined block marking stop condition comprises:
repeatedly performing the moving step and the marking step until all the grid blocks adjacent to each of the cleaning blocks in the grid map are marked.

9. The method according to claim 1, further comprising:
acquiring a plurality of cleaning regions in the cleaning map according to each of the cleaning blocks in the cleaning map,
wherein the controlling the swimming pool cleaning robot to traverse each of the cleaning blocks in the cleaning map to clean the swimming pool comprises:
an inter-region moving step of controlling the swimming pool cleaning robot to move in different cleaning regions on the basis of a predetermined path-finding algorithm;
an intra-region moving step of controlling the swimming pool cleaning robot to move in each of the cleaning regions on the basis of a predetermined cleaning movement algorithm; and
alternately performing the inter-region moving step and the intra-region moving step until the swimming pool cleaning robot traverses each of the cleaning regions in the cleaning map.

10. The method according to claim 9, wherein the acquiring the plurality of cleaning regions in the cleaning map according to each of the cleaning blocks in the cleaning map comprises:
identifying a non-contiguous single cleaning block in the cleaning map, and acquiring a cleaning region comprising the single cleaning block; or
identifying a plurality of cleaning blocks that are in a same row or column and contiguous in the cleaning map, and acquiring a cleaning region comprising the plurality of cleaning blocks.

11. The method according to claim 9, wherein each of the cleaning regions comprises two region endpoints, the region endpoints are determined by the cleaning blocks at two ends of the cleaning region, and the inter-region moving step comprises:
determining a region endpoint having a shortest movement distance from the swimming pool cleaning robot as a target endpoint on the basis of the predetermined path-finding algorithm according to region endpoints of a cleaning region where the swimming pool cleaning robot is currently located, and two region endpoints of each of cleaning regions that are not cleaned in the cleaning map;
determining a cleaning region comprising the target endpoint as a cleaning region to be cleaned by the swimming pool cleaning robot;
controlling, on the basis of the predetermined path-finding algorithm, the swimming pool cleaning robot to move towards the target endpoint to move from the cleaning region where the swimming pool cleaning robot is currently located to the cleaning region to be cleaned; and
continuing to perform the intra-region moving step in response to updating the cleaning region to be cleaned as the cleaning region where the swimming pool cleaning robot is currently located.

12. The method according to claim 11, wherein the intra-region moving step comprises:
determining one region endpoint matching the target endpoint in the two region endpoints of the cleaning region where the swimming pool cleaning robot is currently located as a starting endpoint;
determining the other region endpoint in the two region endpoints as an ending endpoint;
controlling the swimming pool cleaning robot to move from the starting endpoint to the ending endpoint to traverse each of the cleaning blocks in the cleaning regions; and
continuing to perform the inter-region moving step.

13. The method according to claim 9, further comprising:
determining a region endpoint that has a shortest movement distance from the swimming pool cleaning robot and located at an edge position of the cleaning map as a target endpoint on the basis of the predetermined path-finding algorithm according to a cleaning block in the cleaning map where the swimming pool cleaning robot is currently located, and two region endpoints of each of cleaning regions that are not cleaned in the cleaning map;
determining a cleaning region comprising the target endpoint as a cleaning region to be cleaned by the swimming pool cleaning robot;
controlling the swimming pool cleaning robot to move towards the target endpoint on the basis of the predetermined path-finding algorithm, updating the cleaning region to be cleaned as the cleaning region where the swimming pool cleaning robot is currently located in response to reaching the target endpoint; and
continuing to perform the intra-region moving step.

14. The method according to claim 1, wherein a size of each of the grid blocks in the grid map is determined on the basis of a predetermined stepping distance of the swimming pool cleaning robot.

15. The method according to claim 7, wherein the predetermined path-finding algorithm comprises an A-STAR algorithm.

16. An electronic device, comprising:
a processor; and
a memory storing a program,
wherein the program comprises one or more instructions, and the processor, when executing the one or more instructions, is caused to perform operations of:
controlling a swimming pool cleaning robot to move, with respect to a grid map covering the swimming pool, in a work area defined in the swimming pool to establish a cleaning map comprising a plurality of cleaning blocks; and
controlling the swimming pool cleaning robot to traverse each of the cleaning blocks in the cleaning map to clean the swimming pool.

17. The electronic device according to claim 16, wherein the controlling the swimming pool cleaning robot to move, with respect to the grid map covering the swimming pool, in the work area defined in the swimming pool to establish the cleaning map comprising the plurality of cleaning blocks comprises:
controlling the swimming pool cleaning robot to move, with respect to the grid map, in the work area defined in the swimming pool to determine the plurality of cleaning blocks in the grid map; and
establishing the cleaning map according to the plurality of cleaning blocks determined in the grid map.

18. The electronic device according to claim 17, wherein the controlling the swimming pool cleaning robot to move, with respect to the grid map, in the work area defined in the swimming pool to determine the plurality of cleaning blocks in the grid map comprises:
a moving step of controlling the swimming pool cleaning robot to move with respect to the grid map according to a predetermined map establishment movement algorithm;
a marking step of marking a grid block reachable by the swimming pool cleaning robot in the grid map as a cleaning block and marking a grid block unreachable by the swimming pool cleaning robot in the grid map as a non-cleaning block, according to a movement result of the swimming pool cleaning robot with respect to the grid map; and
alternately performing the moving step and the marking step until the grid map satisfies a predetermined block marking stop condition.

19. The electronic device according to claim 18, wherein the moving step comprises:
determining a grid block in the grid map where the swimming pool cleaning robot is currently located as a current block;
determining at least one grid block that is adjacent to the current block and is not marked in the grid map as a candidate block on the basis of the current block;
determining a target block in the candidate block on the basis of the predetermined map establishment movement algorithm; and
controlling the swimming pool cleaning robot to move from the current block to the target block.

20. A non-transitory computer-readable storage medium storing one or more computer instructions, wherein the one or more computer instructions, when executed by a computer, cause the computer to perform operations of:
controlling a swimming pool cleaning robot to move, with respect to a grid map covering the swimming pool, in a work area defined in the swimming pool to establish a cleaning map comprising a plurality of cleaning blocks; and
controlling the swimming pool cleaning robot to traverse each of the cleaning blocks in the cleaning map to clean the swimming pool.
